(19) United States
(12) Patent Application Publication
(10) Pub. No.: US 2002/0109059 A1
(43) Pub. Date: Aug. 15, 2002

(54) Roofing bracket

(76) Inventors: Joseph P. Macri, Rome, NY (US); Frank Mellace JR., Rome, NY (US)

Correspondence Address: David M. Giglio Esq., 231 Elizabeth St, Utica, NY, 13501, US

(21) Appl. No.: 09/783,166

(22) Filed: Feb. 15, 2001

(51) Int. Cl. E04G 3/08; E06B 7/28

(52) U.S. Cl. 248/237; 248/200

(57) ABSTRACT

A roofing bracket for use with a platform for working on a roof. The roofing bracket includes a base having a proximal and distal end. At least one nail slot is disposed through the base near its distal end. A platform support arm is disposed along said base and includes a bottom lip, a platform support and an L-shaped guardrail. A backside support is contiguous with and substantially perpendicular to the proximal end of the base. The backside support includes an angled lip, wherein the angled lip is attached with a rear portion of the platform support. A heel extends from the backside support. Finally, at least one angle brace is disposed between the backside support and the platform support. The heel and angle brace cooperate to provide a roofer with easy means in which to remove the bracket after use, such that the bracket nor roofing shingles are destroyed.

### BACKGROUND OF THE INVENTION

1. Technical Field

The present invention relates generally to an apparatus for assisting a roofer performing work on a roof, and, more particularly to an apparatus which is secured to a roof and supports a platform so that the roofer can work off of the platform.

2. Background Art

Roofing brackets are well known in the art of roofing. Shown in FIG. 1 is a roofing bracket 10 of the prior art. The roofing bracket 10 used in conjunction with a platform allows a roofer to gain access to higher positions on a roof. In use, a roofer lifts a portion of an upper shingle and places the roofing bracket 10 over a tar saturated portion of a lower shingle. The roofer drives a nail into each nail slot disposed through the roofing bracket. Typical roofing brackets include three nail slots.

Once the roofing bracket 10 is secure in place, the roofer inserts a platform into a platform support arm 24 between at least two roofing brackets. At this point, the roofer uses the platform as support and to hold tools and supplies.

When the roofer finishes his work, he must remove the roofing bracket 10. One method for removing the roofing bracket 10 is to pry the bracket 10 out at the nailed slotted portions. However, this proves difficult and often destroys parts of the upper shingle. Further, the nails are very difficult to pry from several types of wood used on roofs, such as tongue and groove pieces.

Another method more commonly used is to strike a backside support 42 of the roofing bracket 10 with a hammer, so that the bracket 10 will slide along the nails at slotted channels until the roofing bracket 10 becomes disengaged. However, this is difficult because the backside support 42 of the roofing bracket 10 often collapses, thus destroying the bracket 10.

### OBJECTS AND SUMMARY OF THE INVENTION

It is therefore an object of the present invention to overcome the problems associated with the prior art, as discussed above, and to provide an improved roofing bracket.

It is another object of the present invention to provide a roofing bracket that is easily removed from the roof when finished in use.

It is a further object of the present invention to provide a roofing bracket that stays intact during its removal from the roof.

It is yet another object of the present invention to provide a roofing bracket that can be removed without destroying any installed shingles.

It is yet a further object of the present invention to provide a roofing bracket that is durable so that it can be reused time and time again.

It is still another object of the present invention to provide a roofing bracket that can be manufacture in a simple manner.

It is still a further object of the present invention to provide a roofing bracket such that the backside support does not collapse when struck with a hammer.

These and other objects are attained in accordance with the present invention wherein there is provided a roofing bracket for use with a platform and having a base with a proximal and distal end. At least one nail slot is disposed through the base near its distal end. A platform support arm is disposed along said base and includes a bottom lip, a platform support and an L-shaped guardrail. A backside support is contiguous with and substantially perpendicular to the proximal end of the base. The backside support includes an angled lip, wherein the angled lip is attached with a rear portion of the platform support. A heel extends from the backside support. Finally, at least one angle brace is disposed between the backside support and the platform support.

In various embodiments, the heel is of a different color than the color of the backside support. The heel may be disc-shaped and include a thickness that is greater than the thickness of the backside support. The disc-shaped heel includes a diameter that is equal to the width of the backside support.

The at least one angle brace is preferably triangular shaped and extends from the front side of the backside support to the back side of the platform support. Various other sizes and shapes can also make an effective angle brace.

The roofing bracket of the present invention can be one-piece cast or manufactured from several different components. In one preferred embodiment, the base, backside support, heel and angle brace are all one-piece cast together. The platform support arm is then riveted to the one-piece cast.

### BRIEF DESCRIPTION OF THE DRAWINGS

Further objects of the present invention will become apparent from the following description of the preferred embodiments with reference to the accompanying drawings, in which:

FIG. 1 is a side-elevation view of the roofing bracket of the prior art;

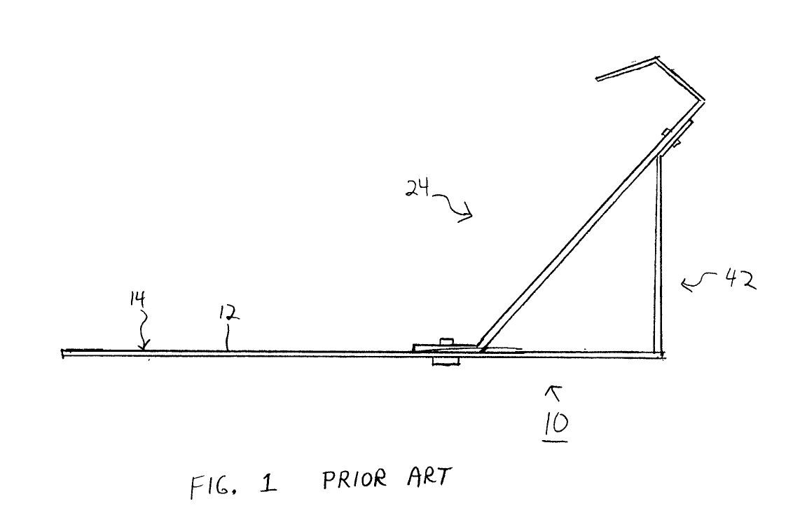

FIG. 2 is a side-elevation view of the roofing bracket of the present invention;

FIG. 3 is a perspective view of the roofing bracket of FIG. 2; and

FIG. 4 is a side-elevation view of the roofing bracket of FIGS. 2 and 3 shown in use on a typical roof.

### DETAILED DESCRIPTION OF A PREFERRED EMBODIMENT OF THE PRESENT INVENTION

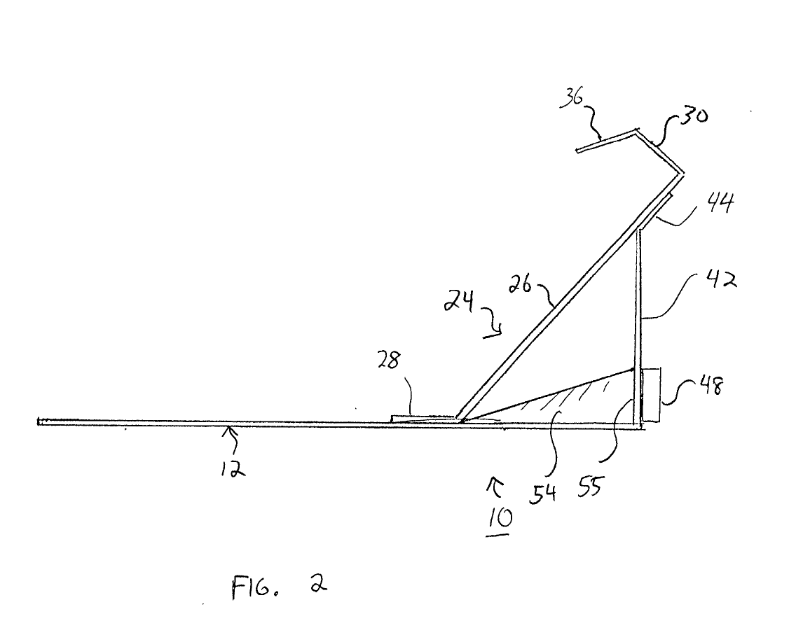

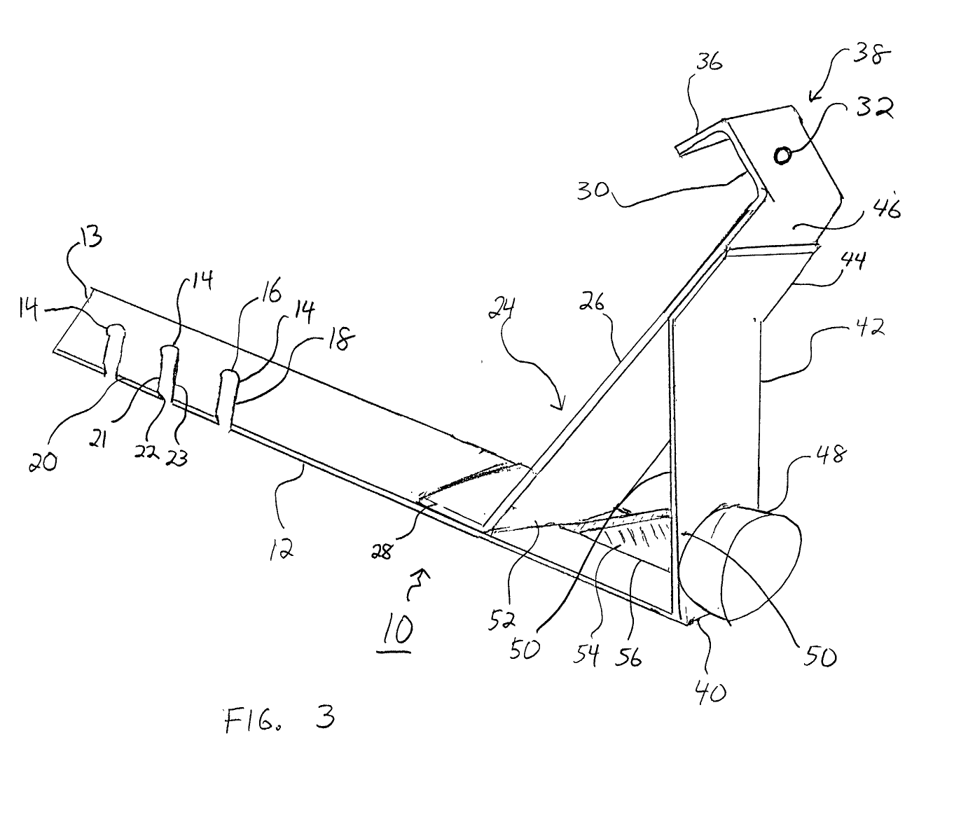

Referring now to FIGS. 2-3, the roofing bracket 10 of the present invention shall be described in detail. The roofing bracket 10 includes a flat bottomed base 12 having a plurality of nail slots 14 disposed therethrough. The nail slots 14 include an arcuate head portion 16 which opens into a rearwardly running slanted channel 18. The slanted channel 18 runs continuously until a lateral edge 20 of the base 12 is reached. At the lateral edge 20, the distal edge 13 of the slanted channel 18 bevels rearwardly.

Moving rearwardly along the base 12, a platform support arm 24 includes a platform support 26 and a bottom lip 28, wherein the bottom lip 28 mounts to the base 12. It is desirable that the angle of the platform support 26 relative to the base 12 matches the pitch of the roof.

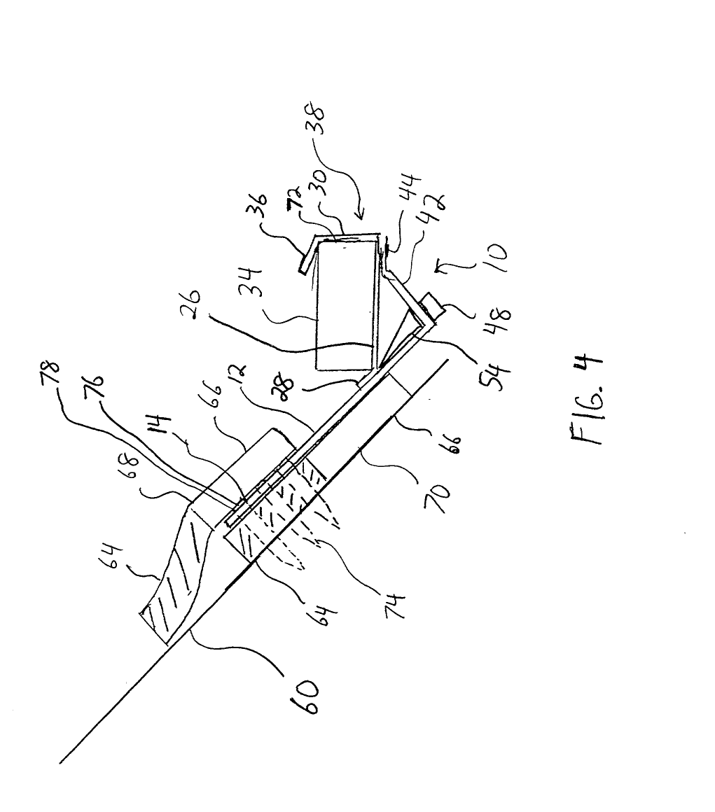

Moving upward along the platform support arm 24, a top support member 30 disposed on the upward edge of the platform support 26 runs perpendicular to the platform support 26. The top support member 30 includes an opening 32 that allows a nail 74 to be driven therethrough and into a platform 34 (shown in FIG. 4). This nail prevents the platform 34 from moving in any direction.

At the upward edge of the top support member 30, a platform flange cover 36 is disposed in a downward angled forward facing direction. The top support member 30 and platform flange cover 36 form an L-shaped guardrail 38 having an angle that is slightly greater than ninety degrees. The L-shaped guardrail 38 prevents the platform 34 from moving upward or forward. By having the angle of the L-shaped guardrail 38 greater than ninety degrees, it becomes easier to install and remove the platform 34 from the roofing bracket 10.

Once again moving rearward along the base 12 and to its proximal end 40, a backside support 42 is disposed upwardly and perpendicular from the proximal end 40 of the base 12. The backside support 42 includes an angled lip 44 that mounts to the rear side 46 of the platform support 26 and aligned in the same direction as the platform support 26. The mounting means for the angled lip 44 of the backside support 42 to the platform support 26 and the mounting means for the platform support arm bottom lip 28 to the base 12 will be discussed later.

A heel 48 extends from the lower back side 50 of the backside support 42. In a preferred embodiment, the heel 48 is disc-shaped having a uniform thickness. It is preferred, but not necessary, that the diameter of the disc-shaped heel 48 be roughly equivalent to the width of the backside support 42. It is preferable but not necessary that the thickness of the disc-shaped heel 48 be greater than the thickness of the backside support 42. In a preferred embodiment, the thickness of the backside support 42 is approximately one eighth inch, while the thickness of the disc-shaped heel 48 is slightly greater than three eighths inch.

While this invention is described according to a preferred embodiment, it is not necessary that the heel 48 be disc-shaped. Other heel shapes will suffice.

Looking now between the front side 50 of the backside support 42 and the bottom rear side 52 of the platform support 24, there is disposed a triangular shaped angle brace 54. The bottom surface 56 of the angle brace 54 mounts longitudinally along the center of the base 12. A rear end 55 of the angle brace 54 mounts longitudinally to the front side 50 of the backside support 42. In a preferred embodiment, the height of the rear end 55 of the angle brace 54 is roughly equivalent to the diameter of the disc-shaped heel 48. Although the shape of the angle brace 54 has been described as being triangular shaped, it should be apparent to one skilled in the art that other angle brace shapes can also be effective, or that a plurality of angle braces can also be utilized.

Turning back to the mounting means between the platform support arm bottom lip 28 to the base 12 and backside support angle lip 44 to the platform support 26, it should be noted that typical mounting means are known in the art and include welding and/or riveting. It has been common in the art to rivet because the roofing brackets 10 are banged often with hammers, which destroys welded joints quicker than riveted joints.

With respect to the base 12, backside support 42, heel 48 and angle brace 54, it is preferable to one piece die cast using an appropriate metal such as steel. It is also plausible to weld or rivet the heel 48 and/or angle brace 54 when forming the roofing bracket 10 of the present invention.

Turning now to FIG. 4, there is shown a roofing bracket 10 of the present invention in use on a roof 60. A roofing shingle 62 typically consists of a thick tar saturated material upper part 64 and a granular showy lower part 66. The granular showy lower part 66 of an upper shingle 68 conceals the thick tar saturated upper part 64 of a lower shingle 70. A roofer starts at the bottom of the roof and works his way up to the peak of the roof.

In order to gain access to a higher point on the roof, at least two roofing brackets are set apart a distance side by side. The platform, typically a 2×6, 2×8, 2×10 or 2×12 is securely placed onto the platform support arms 24 so that one side edge 72 of the platform fits snugly inside the L-shaped guardrail 38 of the roofing brackets 10. The roofer uses the platform 34 as a means of storing tools and materials and to support his body weight.

Prior to placing the platforms 34 onto the roofing brackets 10, the roofing brackets 10 must be set in place. The roofer peels back the granular showy lower part 66 of an upper shingle 68. The roofing bracket 10 is placed over the lower shingle 70 so that the plurality of nail slots 14 are disposed over the thick tar saturated upper part 64 of the lower shingle 70. The roofer drives a nail 74 through the arcuate head portion 16 of each nail slot 14 until the nail head 76 contacts the upper surface 78 of the roofing bracket base 12.

After using and removing the platform 34, the roofer removes the roofing bracket 10 by tapping sharply with a hammer head squarely onto the disc-shaped heel 48 of the roofing bracket 10. In a preferred embodiment, the disc-shaped heel 48 is of a different color than the color of the backside support 42 so as to provide the roofer with a more visible striking target.

As previously described, the nail slots 14 include an arcuate head portion 16 disposed along the central longitudinal axis of the base 12. The arcuate head portion 16 opens into a backwardly directed slanted channel 18 such that when the heel 48 is struck with the hammer, the base 12 is urged into the direction of its distal end 13 and away from the direction that the slanted channel 18 runs from the arcuate head portion 16. The slanted channels 18 run until they reach a beveled portion 22 on the distal side 21 of the slanted channel 18 at which point the beveled portion 18 and the proximal side 23 of the slanted channel 18 open at a lateral edge 20 of the base 12.

The triangular angle brace 54 extends between the front side 50 of the backside support 42 to the lower rear side 52 of the platform support 26. As the hammer strikes the heel 48, the angle brace 54 serves several functions. First, the angle brace 54 causes the force of the strike to transfer substantially longitudinally along the base 12, thereby causing the base 12 to shift uniformly forward.

Second the angle brace 54 acts as a brace that prevents the backside support 42 from collapsing as the heel 48 is struck with the hammer head.

As the force of the hammer causes the base 12 to shift in a forward direction, the slanted channels 18 of the nail slots 14 ride along a side edge of their respective nails 74 until the nail slots 14 become completely disengaged from the nails 74. At this point, the roofer completely removes the roofing bracket 10 and pounds the nails 74 into the thick tar saturated part 64 of the under shingle 70.

While the preferred embodiments of the invention have been particularly described in the specification and illustrated in the drawings, it should be understood that the invention is not so limited. Many modifications, equivalents and adaptations of the invention will become apparent to those skilled in the art without departing from the spirit and scope of the invention as defined in the appended claims.

What we claim is:

1. A roofing bracket for use with a platform, said bracket including:
A base having a proximal and distal end and at least one nail slot disposed therethrough towards the distal end of said base;
A platform support arm having a bottom lip superpositioned and attached to base, further having a platform support extending from said bottom lip, said platform support arm further having an L-shaped guardrail contiguous with said platform support;
A backside support contiguous with and substantially perpendicular to the proximal end of said base, said backside support including an angled lip, said angled lip being attached with a rear portion of said platform support;
A heel extending from the rear of said backside support; and
at least one angle brace having a bottom surface contiguous to the upper surface of said base, said angle brace including a rear surface contiguous to a front surface of said backside support, said angle brace disposed between a rear surface of said platform support and the front surface of said backside support.

2. The roofing bracket of claim 1, wherein said heel is disc-shaped.

3. The roofing bracket of claim 1, wherein the backside of said heel is of a different color than the backside of said backside support.

4. The roofing bracket of claim 1, wherein said heel is disc-shaped and having a diameter, and wherein said backside support includes a backside width, said diameter and backside width being equal.

5. The roofing bracket of claim 1, wherein said backside support includes a backside support thickness and wherein said heel include a heel thickness, said heel thickness being greater than said backside support thickness.

6. The roofing bracket of claim 5, wherein said heel thickness is at least twice the thickness of said backside support thickness.

7. The roofing bracket of claim 1, wherein said angle brace is triangular shaped including a lower edge having a lower edge length and a backside edge having a backside edge length.

8. The roofing bracket of claim 7, wherein said heel is disc-shaped having a diameter, said backside edge length of said angle brace being the same as said disc-shaped diameter.

9. The roofing bracket of claim 7, wherein said lower edge extends from the front side of said backside support to the back side of said platform support.

10. The roofing bracket of claim 9, wherein said base includes longitudinal center wherein said lower edge is disposed longitudinally along the longitudinal center of said base.

11. The roofing bracket of claim 1, wherein said base, said backside support, said heel and said angle brace are cumulatively one piece cast.

12. The roofing bracket of claim 1, wherein said roofing bracket is one piece cast.

13. The roofing bracket of claim 1, including two parallel spaced angle braces.

14. The roofing bracket of claim 1, wherein the front side of said backside support, a portion of the back side of said platform support and the top surface of said base between the lower edge of said backside support and the lower edge of said platform support form a triangular shaped volume having a thickness being the width of said base, and wherein said angle brace is the same shape and size as the triangular shape of the triangular shaped volume and disposed on the longitudinal axis of said base.

15. The roofing bracket of claim 1, wherein said angle brace extends from the front side of said backside support to the rear surface of said platform support.
